(19) United States
(12) Patent Application Publication
(10) Pub. No.: US 2003/0078947 A1
(43) Pub. Date: Apr. 24, 2003

(54) Methods for assigning unique identifiers in a distributed fault tolerant application

(75) Inventors: Ashwani Garg, Bangalore (IN); Chirayu Patel, Bangalore, IN (US); Vishal Batra, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: INTEL CORPORATION

(21) Appl. No.: 09/998,037

(22) Filed: Nov. 29, 2001

Related U.S. Application Data
(60) Provisional application No. 60/329,058, filed on Oct. 12, 2001.

(51) Int. Cl. G06F 12/00

(52) U.S. Cl. 707/204

(57) ABSTRACT

Unique identifiers are created within a distributed application running on a distributed computer system. The unique identifiers are created by the various application copies, without reference to any central broker or synchronization mechanism. The identifiers include a local identifier component and a set label component. The identifiers are associated with identifier sets. The identifier sets are used to facilitate efficient communication within the distributed system, dynamic load balancing and implementation of fault tolerance.

### FIELD OF THE INVENTION

This invention relates to computer systems, and more particularly to unique identifiers and methods for their use in a distributed application.

### BACKGROUND

Modern computing environments frequently make use of distributed systems in order to speed up data processing rates. In a distributed system, multiple copies of a single computer application are distributed across multiple processors to provide higher traffic-handling capacity. Each application copy receives and processes part of the data while the other application copies are processing other parts of the data. In other words, events external to the application are distributed to the various application copies, using well-known methods.

To ensure correct functioning of the distributed system during the processing of the events and data, the application sometimes needs to generate unique identifiers. For example, unique identifiers are generated by applications that are establishing and releasing connections, such as Transmission Control Protocol (TCP) in Internet Protocol (IP) stack or Signaling Connection Control Part (SCCP) in Signaling System 7 (SS7) stack. A unique identifier is assigned to every new connection that is created. These identifiers often are not re-used for some time after the connection has been released.

Unique identifiers are also generated when the application needs to fragment data, and then re-assemble it later on. For example, using SCCP in an SS7 network, a unique identifier may be associated with the segments of a single packet, so that the associated segments can be re-assembled properly at the other end of the network connection. A further need for unique identifiers is to assign a reference number to each of a series of messages sent across a network, e.g., when using a cookie in a Hypertext Transmission Protocol (HTTP) message. A unique identifier in the cookie of the HTTP messages can be used to deliver the messages to the correct HTTP server.

When the application that is generating these identifiers is distributed across multiple processors, various methods are used to generate unique identifiers. One method of generating the identifiers requires each copy of the application to use some sort of synchronization protocol before generating the unique identifier, to synchronize with all of the other application copies and confirm that the identifier generated was in fact unique across all the copies of the distributed application. For example, the generating application copy could message all of the other application copies whenever it generates a new identifier.

Another method of generating the identifiers designates one application copy to generate all of the identifiers to be used by all of the copies in the distributed application. In this method, each application copy sends a request to the designated copy for an identifier. In response, the designated copy generates a unique identifier and returns it to the requesting copy.

In high workload scenarios for which distributed applications are particularly useful, however, the number of synchronizations or number of identifier requests made to the designated copy in the above methods becomes quite large. This high volume of synchronizations/requests will likely clog the data paths of the distributed application or the distributed computer system it is running on, resulting in poor performance of the distributed application.

To avoid this sort of overload, it is possible to pre-assign a range of identifiers to each application copy, such that no copy can create an identifier that might be created on another copy. This method, however, is inefficient when implemented on fault tolerant systems or systems that perform dynamic load balancing.

For instance, a fault tolerant system has an active copy of the application, which processes the data, and a standby copy of the application, which waits in reserve in case the active copy fails. In such systems, pre-assigning a range of identifiers to each application copy results in an imperfect takeover when the active copy dies, because the synchronization with the standby copy cannot be guaranteed to be perfect. For example, there might be one or more identifiers that were created just as the active copy was dying, but which were not flagged as having been created. This would result in the standby copy re-using these identifiers, resulting in identifiers that are no longer unique, and thus, the possibility of errors as the data or events associated with the non-unique identifiers is misrouted or misprocessed.

In systems that implement dynamic load balancing, data and events are shifted from one application copy to another during the operation of the distributed application, in an attempt to control the amount of work done by each application copy. When this shifting is done, the range of identifiers associated with the shifted data or events will have to be updated to reflect the fact that the shifted data or events are now running on a different application copy. This range update process can be very complex and time-consuming, which also leads to poor performance of the distributed application.

### BRIEF DESCRIPTION OF THE DRAWINGS

FIG. 1 is a distributed system.

FIG. 2 is a flowchart of a flow of information items through the distributed system of FIG. 1.

FIG. 3 is an identifier used in the distributed system of FIG. 1.

FIG. 4 is a flowchart of a method of assigning unique identifiers in the distributed system of FIG. 1.

FIG. 5 is a flowchart of a method of dynamic load balancing using unique identifiers in the distributed system of FIG. 1.

### DETAILED DESCRIPTION OF THE PREFERRED EMBODIMENTS

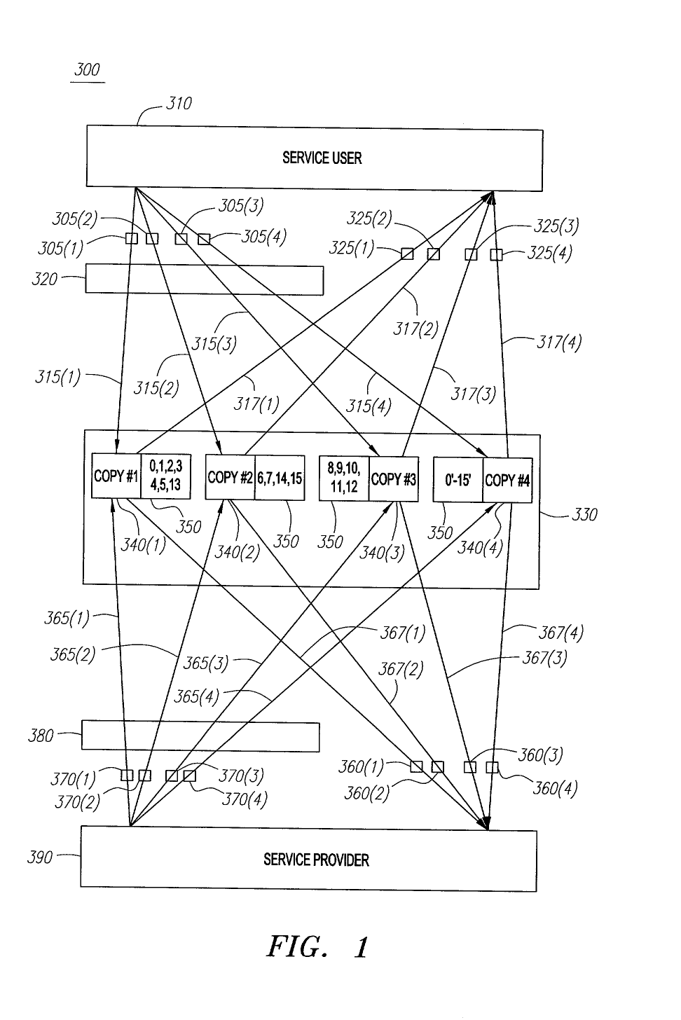

In an embodiment of the invention, a distributed system 300, as shown in FIG. 1, includes at least one service user 310, which can take the form of any entity that sends data to the other components of the distributed system 300. For example, the service user 310 may be a software application running on a processor, or a peripheral device, such as a storage device, input device, or printer. The service user 310 may be linked to other components of the distributed system 300 via a local area network (LAN), wide area network (WAN), the Internet, or any other form of computer network.

The distributed system 300 also includes at least one service provider 390. The service provider 390 can be any entity that provides a service to the distributed application 330. For example, the service provider 390 can be a peripheral device, such as a printer, storage device or database. The service provider 390 could also be an auxiliary processor, a mathematics co-processor, or some other such device useful in processing the information for the distributed application 330. The service provider 390 could also be a software application that provides a service to the distributed application 330. The service provider 390 may be linked to other components of the distributed system 300 via a LAN, WAN, the Internet, or any other form of computer network.

The distributed system 300 also includes a first application load distribution module 320 and a second application load distribution module 380. The application load distribution modules 320, 380 receive information items from the service user 310 and the service provider 390 respectively, and distribute the information items to the various application copies 340 of the distributed application 330.

The distributed system 300 also includes a distributed application 330. The distributed application 330 includes several application copies 340, which are used to process the data flowing to and from the service user 310 and the service provider 390. The application copies 340 can each run on a separate processor, or multiple application copies 340 can operate on a single processor. The application copies can be distributed amongst different processing units, or multiple application copies can run on a single processing unit. The processing units within the distributed application 330 may be linked to other components of the distributed system 300 via a LAN, WAN, the Internet, or any other form of computer network.

In the illustrated embodiment, three application copies 340 are configured as active application copies 340(1)-(3), and one application copy 340 is configured as a standby application copy 340(4). The active application copies 340(1)-(3) are available to process data during normal operation, and the standby application copy 340(4) becomes active when one of the other active application copies 340(1)-(3) fails. This configuration results in the creation of a fault tolerant application.

Each application copy 340 has one or more identifier sets 350 associated with it. For example, identifier sets 350(0)-(5) and 350(13) are associated with the first application copy 340(1); identifier sets 350(6), 350(7), 350(14), 350(15) are associated with the second application copy 340(2); and identifier sets 350(8)-(12) are associated with the third application copy 340(3). To provide fault tolerant capability, identifier sets 350(0)′-(15)′ are associated with the fourth application copy 340(4). As will be described in further detail below, each of the identifier sets 350 contains any number of identifiers that are locally generated within that identifier set 350. As will also be described in further detail below, the specific identifier sets 350 associated with each application copy 340 are dynamic, and thus, may be associated with any one of the application copies 340 at any given time.

The service user 310, service provider 390, distributed application 330, and first and second load application load distribution modules 320 and 380 communicate with each other using various paths. Specifically, a series of outgoing service user information streams 315 contain outgoing information items 305 flowing from the service user 310 to the distributed application 330 via the first application load distribution module 320, and a series of incoming service user information streams 317 contain incoming information items 325 flowing from the distributed application 330 to the service user 310. Similarly, a series of outgoing service provider information streams 365 contain outgoing information items 370 flowing from the service provider 390 to the distribution application 330, via the second application load distribution module 380, and a series of incoming service provider information streams 367 contain incoming information items 360 flowing from the distributed application 330 to the service user 310.

Information items 305, 325, 360, and 370 can either be assigned or unassigned. An assigned information item is an information item that has already been associated with an application copy 340, whereas an unassigned information item is an information item that has not yet been associated with an application copy 340. Assignment of an information item is effected when an identifier set 350 associated with a specific application copy 340 is associated with that information item. As will be discussed in further detail below, an identifier set 350 is associated with an information item by assigning a unique identifier, which contains a set label identifying the identifier set 350, to the information item. Specifics regarding the generation and assignment of the unique identifier will be described in further detail below.

To ensure that the information items 305, 325, 360, and 370 and any information items respectively related thereto are sent to or from the same application copy 340, they are assigned the same identifier set 350. Thus, the first application load distribution module 320 will route all related outgoing information items 305 from the service user 310 to the distributed application 330 along the same outgoing service user information stream 315, and the second application load distribution module 380 will route all related outgoing information items 370 from the service provider 390 to the distributed application 330 along the same outgoing service provider information stream 365. All related incoming information items 325 will be directly routed from the distributed application 330 to the service user 310 along the same incoming service user information stream 317, and all related incoming information items 360 will be directly routed from the service provider 390 to the distributed application 330 along the same incoming service provider information stream 367.

Not only might related information items routed along the same information stream be assigned the same identifier set 350, related information items routed along different information streams might be assigned the same identifier set 350. For example, while repeated query requests for information from the service user 310 to the distributed application 330 may be assigned the same identifier set 350, and thus routed along the same outgoing service user information stream 315 to the same application copy 340, a transmission of the requested information from the distributed application 330 back to the service user 310 may be assigned the same identifier set 350 as that assigned to the query request, and thus routed along an incoming service user information stream 317 from the same application copy 340 used to process the query request. Similarly, a transmission of the requested information to the service provider 390 may be assigned the same identifier set 350 as that assigned to the query request, and thus routed along an incoming service provider information stream 367 from the same application copy used to process the query request.

The service user 310 can generate an outgoing information item 305 either because of an internal decision by the service user 310, or in response to an incoming information item 325. The outgoing information item 305 is sent to the first application load distribution module 320, which in turn, receives the outgoing information item 305 and passes it to an appropriate application copy 340 depending on whether the outgoing information item 305 is assigned. Specifically, if the outgoing information item 305 is already assigned to a particular application copy 340, it is routed to that application copy 340 using the outgoing service user information stream 315 associated with that application copy 340. If, on the other hand, the outgoing information item 305 is not assigned to a particular application copy 340, the first application load distribution module 320 selects an application copy 340 to which the outgoing information item 305 is transmitted. The outgoing information item 305, as well as any subsequent related information items, are associated with the selected application copy 340.

Similarly, the service provider 390 can generate an outgoing information item 370 either because of an internal decision by the service provider 390, or in response to an incoming information item 360. The outgoing information item 370 is sent to the second application load distribution module 380, which in turn, receives the outgoing information item 370 and passes it to an appropriate application copy 340 depending on whether the outgoing information item 370 is assigned. Specifically, if the outgoing information item 370 is already assigned to a particular application copy 340, it is routed to that application copy 340 using the outgoing service provider information stream 365 associated with that application copy 340. If, on the other hand, the outgoing information item 370 is not assigned to a particular application copy 340, the second application load distribution module 380 selects an application copy 340 to which the outgoing information item 370 is transmitted. The outgoing information item 370, as well as any subsequent related information items, is associated with the selected application copy 340.

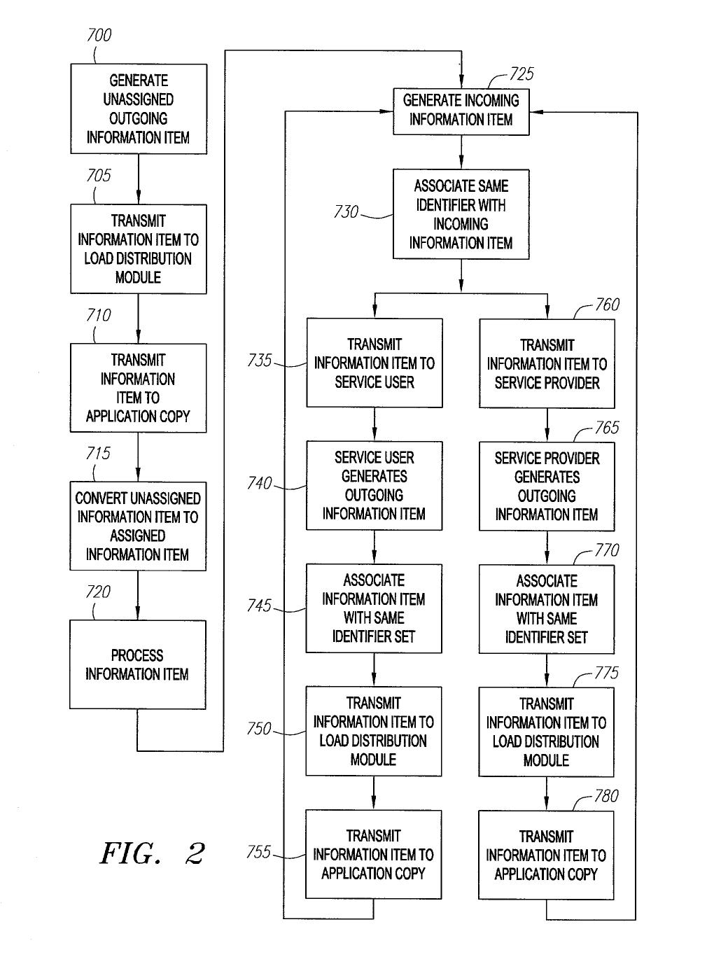

Referring to FIG. 2, a general flow of information within the distributed system 300 and originating from the service user 310 is described. First, the service user 310 generates an unassigned outgoing information item 305, such as a data processing request (step 700). The service user 310 then transmits the unassigned outgoing information item 305 to the first application load distribution module 320 (step 705). The first application load distribution module 320 then selects a specific outgoing service user information stream 315, and thus, a specific application copy 340, that will operate on the unassigned outgoing information item 305. This selection may be based on a variety of factors. For example, the first application load distribution module 320 may select an application copy 340 based on an assessment of the load that the application copy 340 currently has, or the first application load distribution module 320 may select an application copy 340 based on a round-robin scheme. Once selected, the first application load distribution module 320 transmits the outgoing information item 305 to the selected application copy 340 via the corresponding outgoing service user information stream 315 (step 710).

The selected application copy 340 then receives and converts the unassigned outgoing information item 305 to an assigned outgoing information item 305 by associating it with an identifier set 350 (step 715). For example, if the first application copy 340(1) receives the unassigned outgoing information item 305, the application copy 340(1) can associate the identifier set 350(5) with it. This selection can be made based on a wide variety of factors or methods, such as a round robin selection of the next identifier set 350, the load within each identifier set 350, the relative priority of each identifier set's access to system resources in the first application copy 340(1), the relative priority of the unassigned outgoing information item 305 as compared to other information items being processed in the first application copy 340(1), etc. Once assigned, the application copy 340 processes the outgoing information item 305 (step 720) and generates an incoming information item 325 and/or incoming information item 360 (step 725). The application copy 340 then associates the same identifier set 350 with the incoming information item 325 and/or incoming information item 360 that was associated with the outgoing information item 305 (step 730).

If an incoming information item 325 is generated at step 725, the application copy 340 transmits it back to the service user 310 via the incoming service user information stream 317 associated with the same application copy 340 (step 735). Optionally, the service user 310 generates another outgoing information item 305 (step 740), and then associates the same identifier set 350 with other outgoing information item 305 that was associated with the original outgoing information item 305 (step 745). It should be noted that the service user 310 obtains this identifier set 350 from the previously received incoming information item 325. The service user 310 then transmits the assigned outgoing information item 305 to the first application load distribution module 320 (step 750), which in turn, routes the outgoing information item 305 to the same application copy 340 via the corresponding outgoing service user information stream 315 (step 755), as dictated by the identifier set 350 associated with the assigned outgoing information item 305. The process then returns to step 725, where an incoming information item 325 and/or incoming information item 360 can be generated.

If an incoming information item 360 is generated, the application copy 340 transmits it to the service provider 390 via the incoming service provider information stream 367 associated with the same application copy 340 (step 760). The service provider 390 then generates an outgoing information item 370 (step 765), and then associates the same identifier set 350 with the outgoing information item 370 that was associated with the outgoing information item 305 (step 770). It should be noted that the service provider 390 obtains this identifier set 350 from the previously received outgoing information item 360. The service provider 390 then transmits 30 the assigned outgoing information item 370 to the second application load distribution module 380 (step 775), which in turn, routes the outgoing information item 370 to the same application copy 340 via the corresponding outgoing service provider information stream 365 (step 780), as dictated by the identifier set 350 associated with the outgoing information item 305. The process then returns to step 725, where an incoming information item 325 and/or incoming information item 360 can be generated.

The general flow of information within the distributed system 300 and originating from the service provider 390 will be reciprocally similar to that described with respect to FIG. 2, and will thus not be described in further detail, for purposes of brevity.

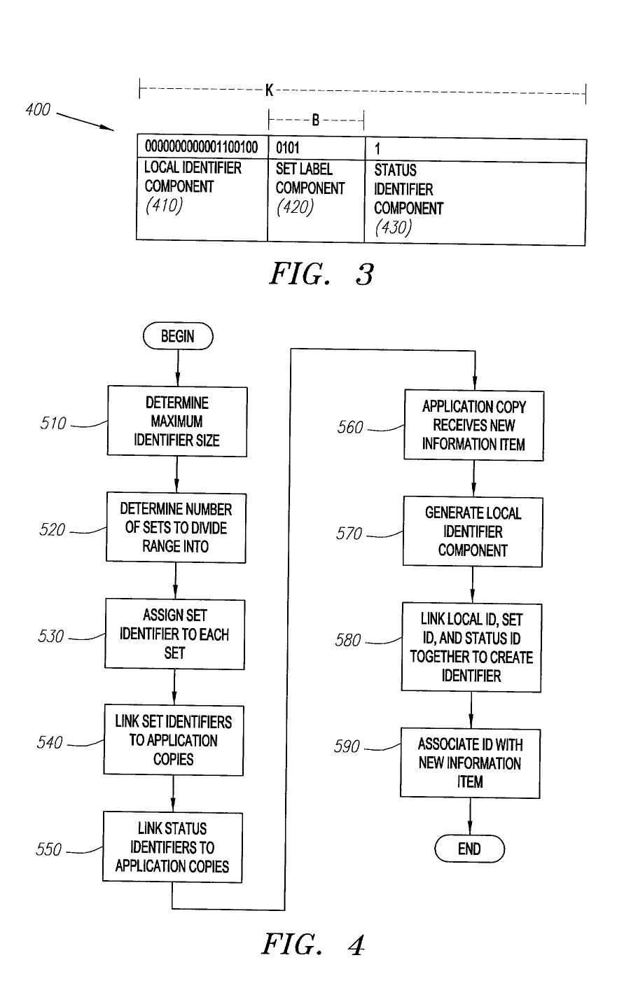

As briefly discussed above, the identifier sets 350 are associated with the various information items by assigning a unique identifier. Referring to FIG. 3, an example of a unique identifier 400 is shown. In describing the identifier 400, it is useful to define the following terms, as shown in Table 1.

TABLE 1

| Term | Definition |
|---|---|
| K | Number of maximum bits in the identifier 400. The identifier |
| | values may range from 0 to 2\hat{ }K − 1 |
| N | The number of identifier sets 350 amongst which the total identifier |
| | range is distributed. This distribution may be an equal |
| | or an unequal distribution. |
| S | Set label component, where S ranges from 0 to N − 1. |
| | Each identifier set 350 is associated with a set label component. |
| | The set label components are unique across the active |
| | application copies 340 within the distributed application 330. |
| | Where the distributed application 330 includes standby application |
| | copies 340, the set label components will be |
| | replicated on the standby application copies 340. |
| C | Number of application copies 340 in the distributed application |
| | 330. C <= N. Thus, each application copy 340 controls |
| | one or more identifier sets 350. The number of identifier |
| | sets 350 controlled by each application copy 340 is decided when |
| | the distributed application 330 is first initialized, |
| | based on the load to be handled by that application |
| | copy 340. If the load scenario subsequently changes, the identifier |
| | sets 350 are redistributed amongst the application copies 340 to |
| | reflect the new load scenario. |
| B | Minimum number of bits needed to represent N. B is the width of |
| | the set label component of the identifier. |
| T | Status identifier component. If the component is 1 then the |
| | identifier is in the active identifier sets 350(0) − (15), |
| | if the component is 0 then the identifier is in the standby |
| | identifier sets 350(0)′ − (15)′. |
| X(S) | A counter associated with identifier set S that wraps back to 0 after |
| | reaching value 2\hat{ }(K − B − T). |
| | This counter generates the local identifier component. |

The identifier 400 includes a local identifier component 410, a set label component 420, and a status identifier component 430. Each component is a binary value of one or more bits. In the example of FIG. 3, the local identifier component 410 is nineteen bits long. Since there are sixteen identifier sets (N=16) defined for the distributed application 330, the set label component 420 (B) is four bits long. Since there is one standby application copy 340(4) provided for the distributed application 330, the status identifier component 430 (T) is one bit long. The identifier 400 shown in FIG. 3 is therefore twenty-four bits long in total (K=24). Other component lengths are also within the scope of other embodiments of the invention. For example, in an embodiment where there are four standby application copies 340, the status identifier component 430 is two bits long (T=2). In an embodiment where there are thirty-two identifier sets 350 defined, the set label component 420 is five bits long (B=5).

The local identifier component 410 is a value that is generated by the application copy 340 that creates the identifier 400. The local identifier component 410 is a value that is unique with respect to all of the other currently-active local identifier components of identifiers associated with the same identifier set 350. For example, where an information item 305 is associated with identifier set 350(5), the local identifier component 410 is unique with respect to all of the other currently active local identifier components of identifiers associated with identifier set 350(5).

The local identifier component 410 is generated by associating a free-running counter with a particular identifier set 350, assigning the current counter value to the local identifier component 410, and then increasing the counter value by one. For example, if there have been one hundred previous identifiers 400 generated in the particular identifier set 350, then the local identifier component 410 for the next identifier generated in the particular identifier set 350 is assigned the value of one-hundred (1100100 binary), since values zero through ninety-nine have already been allocated to previous identifiers 400.

The set label component 420 is a value that identifies the identifier set 350 to which the information item 305 is assigned. For example, if the information item 305 is assigned to identifier set 350(5), the set label component 420 is given the value of five (0101 binary). The status identifier component 430 is a value that further stratifies the identifier 400. In an embodiment, the status identifier component 430 indicates whether the identifier 400 is in the active identifier sets 350 or in the standby identifier sets 350. In an alternative embodiment, the status identifier component 430 contains other information relating to the identifier 400, such as information indicating the identity of the service user 310 or the service provider 390 associated with the information item 305 linked to the identifier 400.

Once the identifier 400 is associated with a particular information stream, such as the first outgoing service user information stream 315(1) or the first outgoing service provider information stream 365(1), then any other information items bearing the same identifier 400 are easily routed to the proper application copy 340 by the application load distribution modules 320, 380, based on the status identifier component 430, the set label component 420, and the mapping between identifier sets 350 and application copies 340. Within a particular identifier set 350 in an application copy 340, the value of the local identifier component 410 differentiates the identifiers 400 from each other.

The identifier 400 discussed above is generated according to the method of FIG. 4. The method starts at step 510, where the distributed application 330 determines the maximum size of the identifier 400. This determination is made when the distributed application 330 is first initialized. A wide variety of factors go into this determination, including considerations such as conformance to a software standard, the underlying hardware architecture, the bus size, the nature of the distributed application 330, the impact on performance of various identifier sizes, the estimated number of identifiers 400 the application will use, etc.

Once the maximum identifier size is determined, then at step 520, the distributed application 330 determines the number of identifier sets 350 amongst which to divide the identifier range, and defines these identifier sets 350. This determination is made based on a number of considerations. For example, a greater number of identifier sets 350 may be assigned to an application copy 340 running on a higher volume processor, so that a larger portion of the identifier range is available to that application copy 340. Other considerations such as granularity of load distribution in the distributed system 300 may also influence the number of the identifier sets 350. The identifier range may be divided into either equal-sized identifier sets 350 or unequal-sized identifier sets 350. The number of identifier sets 350 is chosen such that the set label component 420, when combined with the local identifier component 410 and the status identifier component 430 (all shown in FIG. 3), fits within the maximum identifier bit size.

At step 530, the distributed application 330 maps each identifier set 350 defined above to a set label component 420. This mapping of identifier sets 350 to set label components 420 is unique across the distributed application 330. It is preferable that set label components 420 be assigned sequential values starting from 0, to minimize the number of bits consumed by the set label components 420. Thus, each set label component 420 exists on one of the active application copies 340 at any given time. In an embodiment providing a fault tolerant system, where there is at least one standby application copy 340 provided, the same set label component 420 may exist on an active application copy 340 and a standby application copy 340.

At step 540, the distributed application 330 links the identifier sets 350 to the application copies 340. Each application copy 340 is linked to one or more identifier sets 350. The decision as to which identifier sets 350 and how many identifier sets 350 each application copy 340 is linked to is influenced by a number of factors. For example, the load that each application copy 340 will handle is considered, as is the total number of available identifier sets 350. The links made between the identifier sets 350 and the application copies 340 are sent to the application load distribution modules 320, 380 to allow them to direct information items 305, 370 to the proper application copies 340.

At step 550, the distributed application 330 links the status identifier component 430, and any other information that will be incorporated into the identifiers 400, to the application copies 340. For example, the status of the application copy 340, either active or standby, is linked to the application copy 340. Other linked information could include a code for identifying the service user 310 associated with the application copy 340, the service provider 390 associated with the application copy 340, or any other such information. The links made between the status identifier components 430 and the application copies 340 are sent to the application load distribution modules 320, 380, to allow them to direct information items 305, 370 to the proper application copies 340.

Once the parameters of the identifier 400 have been determined, and the distributed application 330 has been initialized, then at step 560 the application copy 340 receives new information, such as an unassigned outgoing information item 305, or an unassigned outgoing information item 370. This new information can come from a service user 310, from a service provider 390, or from any other source of new information.

At step 570, the application copy 340 generates a new local identifier component 410, by fetching the value stored in a counter associated with one of the identifier sets 350 linked to the application copy 340. As previously discussed, the decision as to which identifier set 350 to choose can be based on multiple schemes. For example—round robin, the relative load on identifier sets 350 linked to the application copy 340, etc. The counter associated with the chosen identifier set 350 is then incremented.

Once the local identifier component 410 is generated, then at step 580 the application copy 340 links the local identifier component 410 with the set label component 420 and any other information, such as the status identifier component 430, to produce the identifier 400 as shown in FIG. 3. The application copy 340 then associates this identifier 400 with the unassigned outgoing information item 305, 370 at step 590 by, for example, being stored as a field in the unassigned outgoing information item 305, 370 or being stored in a network packet header associated with the unassigned outgoing information item 305, 370 or other such means. An identifier 400 which is unique with respect to all other currently-active identifiers is thus generated and associated with the unassigned outgoing information item 305, 370. The method then returns to step 560 to await the next unassigned outgoing information item 305, 370. When the distributed application 330 is finished operating, the method terminates.

From time to time, it becomes desirable to perform dynamic load balancing on the distributed system 300. For example, referring to FIG. 1, where the first application copy 340(1) is overloaded or is taken off-line, loads are transferred from the first application copy 340(1) to other application copies 340. Where the second application copy 340(2) is underloaded, loads are transferred to the second application copy 340(2) from other application copies 340. Where the first application copy 3401(1) fails, the load is shifted to the backup application copy 340(4). The identifiers 400 are well suited to facilitate this load balancing with a minimum of disruption.

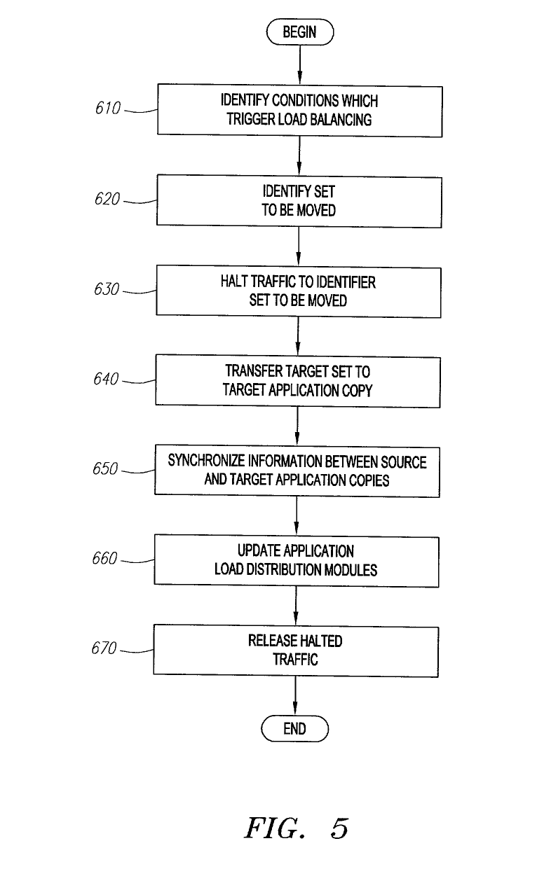

The load balancing operation is performed according to the method of FIG. 5. The method begins at step 610, when the distributed application 330 identifies conditions that trigger load balancing, such as the conditions discussed above. Once the distributed application 330 decides to perform a load balancing operation, then at step 620 the distributed application 330 identifies the target identifier set 350 (the identifier set to be moved). One or more target identifier sets 350 may be moved, depending on the particular circumstances triggering the load balancing operation, as discussed above.

Once the target identifier set 350 is identified, then at step 630 the application load distribution modules 320, 380 halt all traffic being sent to the target identifier set 350. At step 640, the distributed application 330 transfers the target identifier set 350 from the source application copy 340 it currently resides on to the target application copy 340. This transfer is done by changing the mapping of identifier sets 350 to application copies 340 to reflect the fact that the target identifier set 350 is now mapped to the target application copy 340 rather than the source application copy 340. For example, where the mapping of identifier sets 350 to application copies 340 is stored as a table or linked list listing the identifier sets 350 under each application copy 340, the target identifier set 350 is moved from the source application copy 340 list to the target application copy 340 list.

At step 650, the distributed application 330 synchronizes information between the source application copy 340 and the target application copy 340, to insure that any application resources associated with the target identifier set 350 are properly updated in the target application copy 340. For example, the value of the counter associated with the target identifier set 350, as stored in the source application copy 340, is copied over to the target application copy 340. This insures that the identifiers 400 generated after the transfer will not overlap the identifiers 400 generated before the transfer. This synchronization is performed simultaneously with the movement of the target identifier set 350, so that the normal operations on other identifier sets 350 of the distributed application 330 are not disrupted by the synchronization process.

At step 660, the application load distribution modules 320, 380 are updated to reflect the new location of the target identifier set 350, on the target application copy 340. Once the application load distribution modules 320, 380 have been updated, then at step 670 the held traffic is released and normal operations of the distributed application 330 resume.

In some circumstances, for example where the source application copy 340 suddenly fails, it is not possible to synchronize information, such as the value of the counter associated with the target identifier set 350, between the source application copy 340 and the target application copy 340. In these circumstances, the target identifier set 350 is still moved from the source application copy 340 to the target application copy 340, which could be the backup application copy 340(4), as discussed above. Since the counter value has been lost due to the failure of the source application copy 340, the backup application copy 340(4) re-initializes the counter. This may result in the same local identifier component being re-used within the target identifier set 350.

The uniqueness of the identifiers 400 is still preserved under these circumstances, however, by the status identifier component 430. The identifiers 400 generated by the target identifier set 350 while the target identifier set 350 is associated with the source application copy 340 will all have a status identifier component 430 of 0. Once the target identifier set 350 is transferred to the backup application copy 340(4), however, the status identifier component 430 will be 1. Thus, even where a newly-created identifier 400 on the backup application copy 430(4) has the same local identifier component 410 and set label component 420 as an existing identifier 400 that was created on the source application copy 430 before the source application copy 430 failed, the newly created identifier 400 has a status identifier component 430 of 1, and the existing identifier 400 has a status identifier component 430 of 0. Uniqueness is thereby preserved, even when an application copy 340 suddenly fails.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and the invention can be performed using different or additional process actions, or a different combination or ordering of process actions. The specification and drawings are accordingly to be regarded in an illustrative rather than restrictive sense, and the invention is not to be restricted or limited except in accordance with the following claims and their legal equivalents.

We claim:

1. A method of identifying a plurality of information items associated with a computer application, comprising:
associating one or more set label components with the computer application;
generating a plurality of local identifier components;
generating a plurality of identifiers by associating each of the plurality of local identifier components and the set label component; and
associating the plurality of identifiers with the plurality of information items.

2. The method of claim 1, wherein the plurality of local identifier components is sequentially generated.

3. The method of claim 1, wherein each of the plurality local identifier components is unique within a set label component.

4. The method of claim 1, wherein each of the identifiers uniquely identifies an information stream.

5. The method of claim 1, further comprising:
providing a status identifier component indicating a status of the identifier set; and
generating the plurality of identifiers by linking each of the plurality of local identifier components, the status identifier component, and the set label component.

6. The method of claim 5, wherein the status identifier component can indicate one of an active status or standby status.

7. The method of claim 1, wherein each of the plurality of local identifier components and the set label component comprise one or more binary bits.

8. The method of claim 1, wherein the plurality of identifiers are generated by attaching each of the local identifiers components to the set label components.

9. A method of distributing a plurality of information items to a distributed application having a plurality of computer application copies, comprising:
associating a plurality of set label components with the respective plurality of computer application copies;
associating a plurality of identifiers with the plurality of information items, each of the plurality of identifiers comprising one of the set label components and an identifier component local to an identifier set associated with the one set label component; and
distributing the plurality of information items to the plurality of computer application copies in accordance with the plurality of identifiers.

10. The method of claim 9, wherein each of the plurality of identifiers comprises a status identifier component indicating a status of one of the plurality of identifier sets.

11. The method of claim 10, wherein the status identifier component can indicate one of an active status or standby status.

12. The method of claim 9, wherein each of the plurality of identifiers uniquely identifies an information stream.

13. The method of claim 9, wherein each of the local identifier components is unique within the identifier set.

14. A method of transferring an identifier set from a first application copy to a second application copy in a distributed application, the identifier set being associated with a set label component, the set label component being associated with the first application copy, comprising:
transferring the association of the set label component from the first application copy to the second application copy; and
synchronizing information between the first application copy and the second application copy.

15. The method of claim 14, wherein the synchronization occurs during a time period while the identifier set is not available for normal operation.

16. The method of claim 15, wherein the time period while the identifier set is not available for normal operation comprises a period while the identifier set is being transferred from the first application copy to the second application copy.

17. The method of claim 14, wherein the information comprises a most recently used local identifier component value

18. An identifier for use in a distributed application having a plurality of application copies, comprising:
a set label component identifying a set of local identifier components, the set label component being associated with one of the plurality of application copies; and
a local identifier component within the set of local identifier components.

19. The identifier of claim 18, wherein the local identifier component is generated local to the one application copy.

20. The identifier of claim 18, further comprising a status identifier component identifying a status of the one identifier set.

21. The identifier of claim 20, wherein the status identifier component can indicate one of an active status or standby status.

22. The identifier of claim 18, wherein the local identifier component and the set label component comprise one or more binary bits.

23. A computer-usable medium comprising a sequence of instructions which, when executed by a processor, causes the processor to perform a method of identifying a plurality of information items associated with a computer application, comprising:
associating a set label component with the computer application;
generating a plurality of local identifier components;
generating a plurality of identifiers by associating each of the plurality of local identifier components and the set label component; and
associating the plurality of identifiers with the plurality of information items.

24. The computer-usable medium of claim 23, wherein the plurality of local identifier components is sequentially generated.

25. The computer-usable medium of claim 23, wherein each of the plurality of local identifier components is unique.

26. The computer-usable medium of claim 23, wherein each of the identifiers uniquely identifies an information stream.

27. The computer-usable medium of claim 23, further comprising:
providing a status identifier component indicating a status of the identifier set; and
generating the plurality of identifiers by linking each of the plurality of local identifier components, the status identifier component, and the set label component.

28. The computer-usable medium of claim 27, wherein the status identifier component can indicate one of an active status or standby status.

29. The computer-usable medium of claim 23, wherein each of the plurality of local identifier components and the set label component comprise one or more binary bits

30. The computer-usable medium of claim 23, wherein the plurality of identifiers are generated by attaching each of the local identifiers components to the set label component.

31. A computer-usable medium comprising a sequence of instructions which, when executed by a processor, causes the processor to perform a method of distributing a plurality of information items to a distributed application having a plurality of computer application copies, comprising:
associating a plurality of set label components with the respective plurality of computer application copies;
associating a plurality of identifiers with the plurality of information items, each of the plurality of identifiers comprising one of the set label components and an identifier component local to an identifier set associated with the one set label component; and
distributing the plurality of information items to the plurality of computer application copies in accordance with the plurality of identifiers.

32. The computer-usable medium of claim 31, wherein each of the plurality of identifiers comprises a status identifier component indicating a status of one of the plurality of identifier sets.

33. The computer-usable medium of claim 32, wherein the status identifier component can indicate one of an active status or standby status.

34. The computer-usable medium of claim 31, wherein each of the plurality of identifiers uniquely identifies an information stream.

35. The computer-usable medium of claim 31, wherein each of the local identifier components is unique within the identifier set.

36. A computer-usable medium comprising a sequence of instructions which, when executed by a processor, causes the processor to perform a method of transferring an identifier set from a first application copy to a second application copy in a distributed application, the identifier set being associated with a set label component, the set label component being associated with the first application copy, comprising:
transferring the association of the set label component from the first application copy to the second application copy; and
synchronizing information between the first application copy and the second application copy.

37. The computer-usable medium of claim 36, wherein the synchronization occurs during a time period while the identifier set is not available fornormal operation.

38. The computer-usable medium of claim 37, wherein the time period while the identifier set is not available for normal operation comprises a period while the identifier set is being transferred from the first application copy to the second application copy.

39. The computer-usable medium of claim 36, wherein the information comprises a most recently used local identifier component value.
